(19) United States
(12) Patent Application Publication
(10) Pub. No.: US 2015/0131454 A1
(43) Pub. Date: May 14, 2015

(54) Method, Device and Computer Program for Reporting Radio Link Failures (RLF) for Cellular Communication Based on Communication Links Enabled on at Least Two Different Access Technologies

(71) Applicant: Nokia Solutions and Networks Oy, Espoo (FI)

(72) Inventors: Bernhard Wegmann, Holzkirchen (DE); Richard Waldhauser, Munich (DE); Kordybach Krzysztof, Pulawy (PL)

(21) Appl. No.: 14/399,236

(22) PCT Filed: May 11, 2012
(86) PCT No.: PCT/EP2012/058815

§ 371 Date: Nov. 6, 2014

(51) Int. Cl. H04W 24/10; H04L 12/24

(52) U.S. Cl. CPC H04W 24/10; H04L 41/069
USPC 370/242

(57) ABSTRACT

The present invention proposes a User Equipment UE, which includes a transceiver module for cellular communication based on communication links enabled on at least two different access technologies, and a control module, wherein the control module is configured to detect a first event, namely a connection failure on a communication link established using a first access technology, to start, triggered by the detection, a timer, to discern a second event, namely reconnection of a communication link established after the first event and using a first or a second access technology, to stop, triggered by the discerning, the timer and to compose a report, wherein the report includes at least an information element indicative of the time counted by the timer. Likewise, the present invention encompasses a corresponding method and a respective computer program product.

### FIELD OF THE INVENTION

The present invention relates to methods, devices and computer program products for improvements for cellular communication based on communication links enabled on at least two different access technologies. In particular, the present invention relates to such methods, devices, and computer program products applicable in mobile communication systems operating in cellular network environments, in which a terminal is configured for communication based on multiple radio access technologies, RAT, in relation to mobility robustness optimization.

### BACKGROUND

Mobile data transmission and data services are constantly making progress. With the increasing penetration of such services, a terminal apparatus such as a user equipment UE (or mobile station MS, or the like; different names may apply for respective different standards) is capable of communicating within a cellular network environment. For example, a terminal device UE communicates within the network environment in which it is deployed or “camping” based on an available system configuration, generally adopted by a serving network transceiver station (e.g. base station BS or NodeB, or evolved NodeB, eNB) and related network architecture.

Also, with the progress in communication, terminals need to be “backward compatible” as in some areas, the most recent communication network technology is not yet installed to provide for seamless coverage using that technology. Insofar, terminals need to be able to support different radio access technologies, e.g. one or more of GSM (2G), UMTS (3G), LTE (4G), LTE-A, or the like, or also WiMax, WLAN, etc. Those terminals are hereinafter referred to as multi-RAT capable terminals.

In the following, aspects of the invention will be exemplarily described with reference to such a scenario. In order to enhance legibility and understandability of the invention, for explanatory purposes only, reference is made to the communication system of LTE or LTE-A (Long Term Evolution, LTE-Advanced). However, reference to such specific system and use of specific signaling names or channel names or names of entities constituting such a communication network or partial network environment is not intended to limit the present invention to those specific examples. Rather, the principles of the present invention can be transferred to any other communication system adopting different channel/signaling/entity names as compared to LTE/LTE-A.

In case of a (multi-RAT capable) terminal such as a UE communicating in such an environment while being “mobile” and thus moving within the network environment and the coverage of one or more radio access networks (RANs) being based on different radio access technologies (RAT), and respective cells thereof, the terminal may be served by different network transceiver devices eNBs of potentially different RATs over time. In order to change the serving network transceiver device, the terminal needs to be handed over (HO, Handover) from an initially serving network transceiver device (source RAT) to a target network transceiver device of potentially another RAT (which, upon handover, becomes the new serving network transceiver device).

More precisely, the technical field is mobile radio communications with focus on SON (Self Optimizing Networks), and in particular MRO (Mobility Robustness Optimization). SON has become a standard relevant aspect with 3GPP Rel 8 (standardization of E-UTRA, evolved universal terrestrial radio access) and is now with Rel'11 focusing on inter-RAT MRO, i.e. MRO between different RATs.

Traditionally, the optimization of network configuration parameters is based on labor- and cost-intensive drive testing. For the first roll-out, network-wide default configuration parameters are used, and if performance management (PM) counters are accumulating radio link failures (RLFs) or even call drops in certain service areas of a network, several optimization loops with drive testing are started to adapt parameters in a cell-specific manner.

The target of MRO is to automate the optimization of those network configuration parameters, which are triggering a handover (e.g. events, event thresholds used to conclude on a presence of an “event”, timers, etc.) such that radio link failures (RLF) and handover failures (HOF) are reduced.

The MRO procedure consists of two phases:

1) root cause analysis (RCA) phase,

In which radio link failure or handover failure (RLF/HOF) is analyzed in detail, and the cell which is responsible for this failure is detected. Finally, this “guilty” cell is collecting the failure events and generates cell or cell-pair specific key performance indicator (KPI) statistics.

2) correction phase,

The KPI statistics built over certain time interval are evaluated and based on that the corresponding mobility parameters of this cell are adjusted.

The present invention to be described herein below deals with the root cause analysis phase for the inter-RAT MRO procedure, considering solutions currently discussed in 3GPP, where RLF reporting and root cause analysis should be carried on LTE side only (one optional solution discussed in R3-120912, LS to RAN2 “Report email#04 Inter-RAT mobility failure”, 3GPP TSG-RAN WG3#75-bis, San Jose del Cabo, Mexico, March 2012.) That is, another network/other RAT is not intended to be involved in MRO.

The MRO concept as specified in Rel'9 and Rel'10 is based on information elements provided with the “RRC connection re-establishment request” message where connection can easily be re-activated, and based on the RLF report which contains additional information to allow the identification of coverage holes and mobility failures without a subsequent “RRC connection re-establishment request” but reconnection from RRC_IDLE state.

In Rel'9, the availability of an RLF report is indicated by the UE with RRCConnectionReestablishmentComplete only; but with Rel'10, rlf-InfoAvailable is sent by the UE also in RRCConnectionSetupComplete and RRCConnectionReconfigurationComplete.

In addition to the measurements, the RLF report contains following information:
failedPCellId (ECGI(1)), i.e. the ID of the cell where RLF/HOF occurred
reestablishmentCellId (ECGI(2)), i.e. the ID of the cell in which the re-establishment attempt was made after connection failure
connectionFailureType , i.e. one or both of {RLF/HOF}
timeConnFailure, i.e. the time elapsed since the last HO initialization until connection failure (RLF/HOF)
previousPCellId (ECGI(3)), i.e. the ECGI of the source cell from where the UE received last HO command (i.e. RRCConnectionReconfiguration w/ mobilityControlInfo)

The most prominent inter-RAT mobility failure cases are “Late inter-RAT LTE-to-3G” and “Too early 3G-to-LTE”, which are related to the limited LTE coverage deployment scenario mentioned above. For both cases, the connection failure occurs in LTE, and the UE is re-connecting to a 3G cell after failure and RRC_IDLE.

A problem, however, is that the information about re-connection to another RAT in between (before reconnecting to LTE/4G) and the corresponding cell ID of the cell to which reconnection is performed in the other RAT, is missing in RLF report. Though it contains the information about reestablishmentCellId, this does not help, since re-establishment is an intra-LTE process that obviously failed or was not executed.

If an RLF report is to be fetched on LTE when UE is coming back (solution with RLF reporting on LTE side only as mentioned above), the RLF report does not have information that the UE was connected to another RAT in between. Therefore, no information about failed inter-RAT HO is available.

Measurements provided with the RLF report can be checked and if there are good signal strength measurements relating to such another RAT, there is a certain probability that the connection failure was caused by a missed inter-RAT HO.

As mentioned above, the other-RAT related measurements recorded in the RLF report can be used to conclude that the other RAT's coverage continuity has been missed. Note that a multi-mode terminal is enabled in terms of multiple RATs. Each of such modes may thus be considered as representing a RAT. With reference to a particular RAT, each other RAT or mode is sometimes also referred to as “other-RAT. Thus, so-called other-RAT measurements pertain to measurements conducted with reference to another mode or RAT.

But if these measurements are missing in the RLF report, since the inter-RAT measurements have not been triggered, this approach cannot be used.

Namely, inter-RAT measurements are not carried out all the time, since they require transmission gaps to serving cell causing losses in throughput.

The problem to get more detailed knowledge about the RRC_IDLE period (e.g. how long was the UE in RRC_IDLE after the connection failure) has been also discussed in former standardization meetings with respect to intra-LTE mobility, in particular to avoid sending RLF Indication twice.

The problem which is addressed in this invention report, however, results primarily from the requirement that RLF reporting is done on the LTE side only and up to 48 hours might pass between RLF occurrence and RLF reporting, i.e. there is no information whether and when the UE has been re-connected to another RAT, for instance.

Though, it is important to know if a re-connection to another RAT occurred immediately after RLF, since this would indicate that other-RAT coverage was there and inter-RAT mobility should have been happened.

This time aspect, namely the “time elapsed between the connection failure and first successful RRC connection setup after failure”, which is considered in this invention, has been already addressed—even though for other reasons—in R3-102342, Information to be reported in the UE-originated RLF reporting in case of RRC connection setup, 3GPP TSG-RAN3#69, Madrid, August 2010, and R3-103102, Way forward for RLF reporting in Rel 10, 3GPP TSG-RAN3#69bis, Xian, October 2010.

Thus, there is still a need to further improve such systems in relation to inter-RAT connection failures, so as to enable proper operation of terminals in such scenarios, and hence a need to provide improved methods, devices and computer program products for corresponding terminals.

### SUMMARY

Various aspects of examples of the invention are set out in the claims.

According to a first aspect of the present invention, there is provided a method, comprising:
providing for cellular communication based on communication links enabled on at least two different access technologies,
detecting a first event on a communication link established using a first access technology,
starting, triggered by the detecting, a counting of time,
discerning a second event related to a communication link established after the first event and using a first or second access technology,
stopping, triggered by the discerning, the counting of time,
composing a report, wherein the report includes at least an information element indicative of the counted time.

The second event may relate to a communication link established using the first access technology and, in case the counted time is smaller than a threshold value, the report may include an information element indicative that the second event occurred with a tolerable delay.

In case the second event relates to a communication link established using the first access technology and in case the counted time is greater than or equal than a threshold value, the report may include an information element indicative that the second event occurred with an intolerable delay.

In case the second event relates to a communication link established using the second access technology, the report may include an information element indicative of the counted time and an information element indicative of a network and/or corresponding cell in which the second event occurred.

According to a second aspect of the present invention, there is provided a device, comprising a transceiver module providing for cellular communication based on communication links enabled on at least two different access technologies, and a control module, wherein the control module is configured to:
detect a first event on a communication link established using a first access technology,
start, triggered by the detection, a timer,
discern a second event related to a communication link established after the first event and using a first or second access technology,
stop, triggered by the discerning, the timer,
compose a report, wherein the report includes at least an information element indicative of the time counted by the timer.

In case the second event relates to a communication link established using the first access technology and in case the time counted by the timer is smaller than a threshold value, the report may be composed to include an information element indicative that the second event occurred with a tolerable delay.

In case the second event relates to a communication link established using the first access technology and in case the time counted by the timer is greater than or equal than a threshold value, the report may be composed to include an information element indicative that the second event occurred with an intolerable delay.

In case the second event relates to a communication link established using the second access technology, the report may be composed to include an information element indicative of the time counted by the timer and an information element indicative of a network and/or corresponding cell in which the second event occurred.

According to a further aspect of the present invention, there is provided a computer program product, comprising computer-executable components which, when the program is run on a computer, are configured to perform the method aspects as indicated above. The above computer program product/products may be embodied as a computer-readable storage medium.

Thus, performance improvement is based on methods, devices and computer program products which, in at least exemplary embodiments, adopt an UE which is configured to add additional information to the RLF report, provided there is one, when getting back to the connected mode firstly after the RLF.

According to at least exemplary aspects of the invention, one or more of the following advantages can be accomplished:

detection of some inter-RAT mobility failures which otherwise cannot be detected is enabled, and this by virtue of introducing new information elements belonging to a RLF report;

changes to be applied can be limited to terminals mainly, and can be configured easily as software/firmware to the terminals;

a properly working root cause analysis on LTE NW side is allowed for, and

an inter-RAT mobility failure can be uniquely detected based on the additional information.

### BRIEF DESCRIPTION OF DRAWINGS

For a more complete understanding of example embodiments of the present invention, reference is now made to the following descriptions taken in connection with the accompanying drawings in which:

FIG. 1 illustrates a block circuit diagram of a multi-RAT capable terminal UE;

FIG. 2 illustrates an example of flowchart of processing as performed in an example embodiment by the terminal UE.

### DESCRIPTION OF EXEMPLARY EMBODIMENTS

Exemplary aspects/embodiments of the invention will be described herein below.

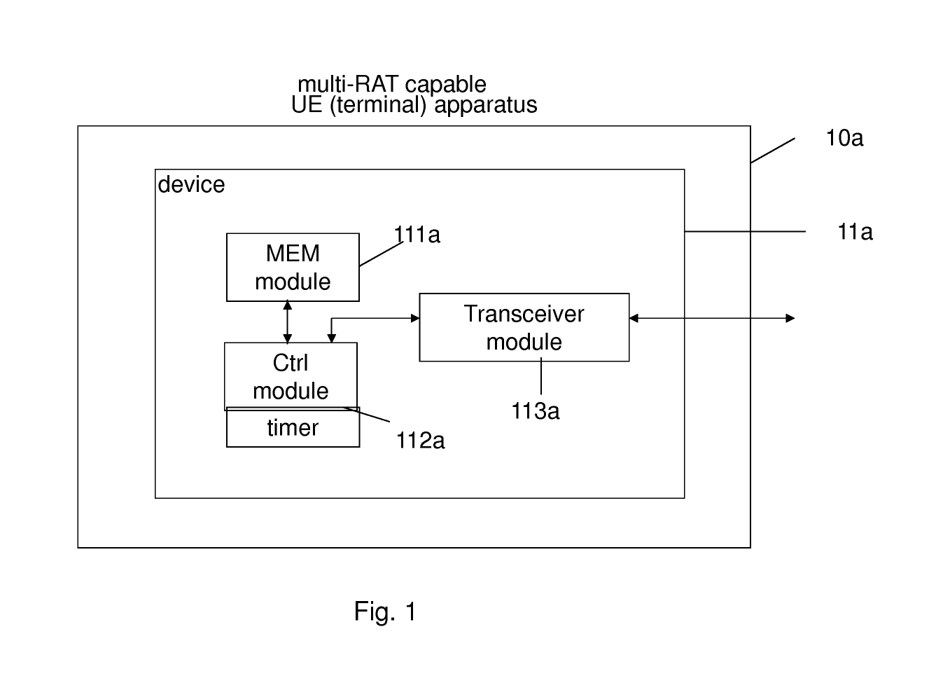

FIG. 1 illustrates a block circuit diagram of a multi-RAT capable terminal UE.

It has to be noted that aspects of this invention are implemented in, at least under an exemplary aspect, a terminal apparatus such as a UE 10a, or in a part thereof such as a device 11a of the UE. A corresponding block circuit diagram of a terminal UE is shown in FIG. 1. Such device 11a can be a chip or chipset, or another subunit of the apparatus 10a, or the like. The device 11a comprises at least a memory module, MEM, 111a in which software code portions and/or data (e.g. measurement data, event data, etc.) is stored or are stored. The memory module 111a is connected to a control module 112a such as a processor, or CPU, or ASIC. The control module 112a comprises a timer and the module 112a is connected to a transceiver module 113a. The transceiver module 113a is configured for communication based on multiple RATs, i.e. configured for the associated service such as LTE, or LTE-A, UMTS, GSM, via network entities such as network transceiver devices with other terminals.

Note that under an implementation aspect of the invention that is software “centric” rather than hardware “centric”, respective modules may even be implemented as corresponding functional means (without departing from the gist of the invention).

Generally, the present invention can be represented as a device or method or computer program product. Generally, such method comprises to provide for cellular communication based on communication links enabled on at least two different access technologies, e.g. LTE and non-LTE (such as UMTS, GSM, WLAN, etc.). It is detected a first event, i.e. a connection failure, e.g. RLF, on a communication link established using a first, i.e. LTE, access technology. Triggered by the detection, a counting of time is started. This can be software based or in a hardware implementation rely on the timer shown in FIG. 1. Related to a communication link established after the first event, and using or relying on a first (LTE) or second (non-LTE) access technology, a second event, i.e. a first re-connection after the first (failure) event is discerned or discovered. Triggered by this, the counting of time/the timer is stopped or suspended. Then, a report, i.e. RLF report, is composed, wherein the report includes at least an information element indicative of the counted time.

In one scenario, for example, in case the second event relates to a communication link established using (again) the first access technology (i.e. again LTE) and in case the counted time is smaller than a threshold value (timer did not expire), the report includes an information element indicative that the second event occurred with a tolerable delay. This also represents a situation that an intra-LTE failure and reconnection occurred “immediately”, i.e. within tolerable delay.

In another scenario, in case the second event relates to a communication link established using the first access technology and

in case the counted time is greater than or equal than a threshold value (timer expired), the report includes an information element indicative that the second event occurred with an intolerable delay. This also represents a situation that an intra-LTE failure and reconnection occurred “late”, i.e. not within a tolerable delay.

And, in a further scenario, in case the second event relates to a communication link established using the second access technology, i.e. e.g. UMTS/3G (rather than LTE), the report includes an information element indicative of the counted time and an (additional) information element indicative of a network and/or corresponding cell in which the second event occurred. The mere presence of the additional information element (IE) can thus be exploited to conclude that an inter RAT reconnection occurred, i.e. after RLF in a first RAT network such as LTE, a reconnection occurred in a second RAT network such as UMTS.

Likewise, the above holds for a corresponding device, comprising a transceiver module providing for cellular communication based on communication links enabled on at least two different access technologies, and a control module, wherein the control module is configured to achieve the above outlined method aspects.

More particularly, the present invention, in a first example embodiment may basically consist of two aspects:

First, a timer is provided for on UE side which measures the time elapsed between RLF and a first reconnection after RLF. Normally the UE sends a RRC Connection Request message to perform a Tracking Area Update (TAU) initiated by the NAS signaling connection recovery. This will be requested by the UE's lower layers after an “RRC Connection failure”, if no signaling link is available or if user uplink data is pending. The timer enables to detect if reconnection was not done immediately and in that case other-RAT coverage continuity cannot be assumed, i.e. it helps in terms of RCA to reveal that the connection failure was not an inter-RAT mobility failure. A RRC connection with UTRAN after connection failure (called “reconnection” for sake of simplicity) can be interpreted as successful already with the ability to send the RRC Connection Request message to a UMTS cell and UE takes this as trigger to stop the timer or UE waits also for reaction from UTRAN, namely getting either the RRC Connection Setup or RRC Connection Reject message that indicates a successful reconnection and takes this as trigger to stop the timer.

Second, an RLF report is extended by the UE by inserting, in this example embodiment, two additional information elements (IE):

1. firstReconnectionCellId, which contains Cell information (incl. RAT/PLMN info, etc.) where UE has reconnected first after the RLF.

2. T_unconn (or reconnType)

Indicating the time that elapsed between RLF and reconnection (or alternatively information indicating if predefined timer expired at the UE—this either is a form of an optional flag or enumerated IE)

When UE comes back to LTE and is providing the RLF report there, based on this additional information an inter-RAT mobility failure can be uniquely detected.

Further, the present invention, in a second example embodiment may basically consist of the following aspects:

Aspects of the invention are implemented in a multi mode LTE/3G/2G-capable UE.

The UE starts a new timer “t_unconn” when it experiences a RLF. When the UE re-connects from idle mode, UE checks if the timer t_unconn is still running. If yes, the timer is stopped and an immediate re-connection after connection failure can be concluded.

If the timer has already expired before, there was no opportunity to follow TAU requirement and to re-connect as soon as possible, i.e. it can be concluded that there is no inter-RAT mobility failure

In all example embodiments (the general, this first and/or the second), the UE has two options to record the information of an immediate reconnection, namely either by storing the elapsed time or by storing an information element which expresses the matter of reconnection, e.g. ENUM {immediately; late} insofar representing a reconnection type; “Immediate” denoting that the timer was not elapsed when reconnection happened, and “late” denoting that the timer elapsed upon reconnection.

In a further modification (third example embodiment), the RLF report needs only be extended if the UE has reconnected first after the RLF to a non-LTE RAN, and “failedPCellId” is a LTE cell. In that case, UE adds the IEs “firstReconnectionCellId” and “T_unconn” (or “reconnType”).

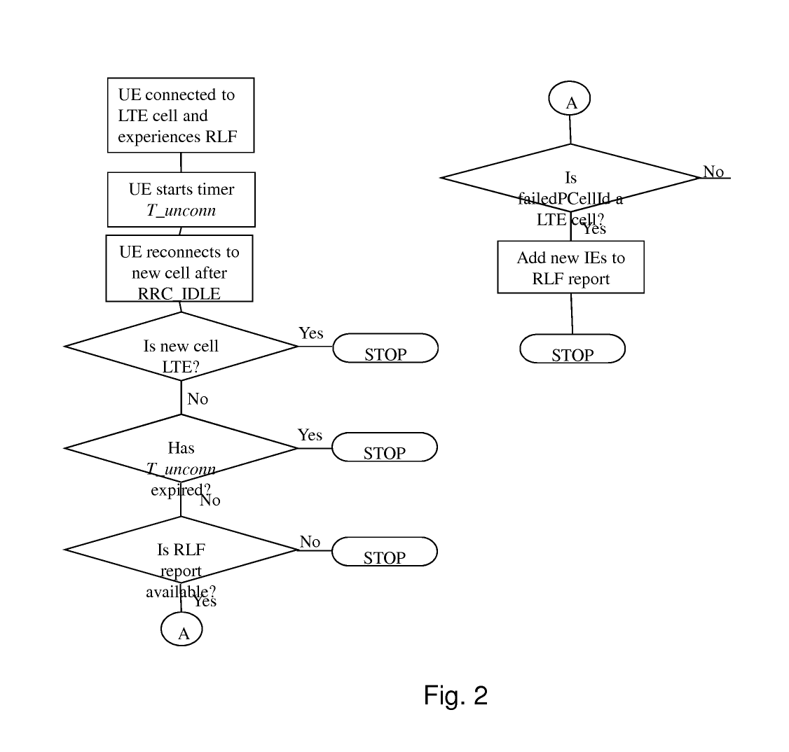

One potential implementation for the above third example embodiment is represented in the flow chart of FIG. 2, illustrating a processing as performed by the terminal UE.

Other systems can benefit also from the principles presented herein as long as they adopt identical or similar properties, e.g. in relation to RLF reports in multi-RAT HO scenarios,

Embodiments of the present invention may be implemented in software, hardware, application logic or a combination of software, hardware and application logic. The software, application logic and/or hardware generally reside on a memory module. A memory module may be a volatile or non-volatile memory module, such as a RAM, ROM, EPROM, EEPROM, or hard disk, or the like. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer or smart phone, or user equipment, or network device such as an evolved NodeB eNB, whether macro or pico eNB.

The present invention relates in particular but without limitation to mobile communications, for example to environments under LTE, LTE-A, and 3G/UMTS and subsequent releases thereof and can advantageously be implemented in user equipments or smart phones, or personal computers connectable to such networks. Particular usefulness will be exhibited for terminals or devices that are multi-RAT enabled, i.e. can operate using multiple radio access technologies.

That is, it can be implemented as/in chipsets to connected devices, and/or modems thereof. More generally, all products which are subject to a similar environment will see performance improvement with the invention being implemented thereto.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

### LIST OF EXEMPLARY ABBREVIATIONS/ACRONYMS USED

UE user equipment
MS mobile station
BS base station
eNB evolved NodeB/enhanced NodeB
LTE Long Term Evolution
LTE-A LTE-Advanced
HO Handover
DL Downlink
UL Uplink
3GPP 3rd Generation Partnership Project
RRC Radio Resource Control
SON Self Optimizing Networks
MRO Mobility Robustness Optimization
RLF Radio Link Failure
HOF HandOver Failure
RCA Root Cause Analysis
IE Information Element
TAU Tracking Area Update
KPI Key Performance Indicator
RAT Radio Access Technology
OAM Operation, Administration and Maintenance
ECGI E-UTRAN Cell Global Identification

The present invention proposes, under a terminal device aspect, a device, a transceiver module providing for cellular communication based on communication links enabled on at least two different access technologies, and a control module, wherein the control module is configured to detect a first event (connection failure, e.g. RLF) on a communication link established using a first (LTE) access technology, start, triggered by the detection, a timer, discern a second event (re-connect) related to a communication link established after the first event and using a first (LTE) or second (non-LTE) access technology, stop, triggered by the discerning, the timer, compose a report (RLF report), wherein the report includes at least an information element indicative of the time counted by the timer. Likewise, the present invention encompasses corresponding methods and respective computer program products.

1-9. (canceled)

10. A method, comprising:
providing for cellular communication based on communication links enabled on at least two different access technologies,
detecting a first event on a communication link established using a first access technology,
discerning a second event related to a communication link established after the first event and using a first or second access technology,
composing a report, wherein the report includes, in case the second event relates to a communication link established using the second access technology, an information indicative of a network and/or corresponding cell in which the second event occurred.

11. A method according to claim 10, further comprising:
starting, triggered by the detecting, a counting of time,
stopping, triggered by the discerning, the counting of time, and
including in the report an information element indicative of the counted time.

12. A method according to claim 11, wherein
in case the second event relates to a communication link established using the first access technology and
in case the counted time is smaller than a threshold value,
the report includes an information element indicative that the second event occurred with a tolerable delay.

13. A method according to claim 11, wherein
in case the second event relates to a communication link established using the first access technology and
in case the counted time is greater than or equal than a threshold value, the report includes an information element indicative that the second event occurred with an intolerable delay.

14. An apparatus comprising:
a transceiver module providing for cellular communication based on communication links enabled on at least two different access technologies,
at least one processor; and
at least one memory including computer program code, the at least one memory and the computer program code configured, with the at least one processor, to cause the apparatus to perform at least the following:
detect a first event on a communication link established using a first access technology,
discern a second event related to a communication link established after the first event and using a first or second access technology,
compose a report, wherein the report includes, in case the second event relates to a communication link established using the second access technology, an information indicative of a network and/or corresponding cell in which the second event occurred.

15. An apparatus according to claim 14, the at least one memory and the computer program code configured, with the at least one processor, to cause the apparatus to further
to start, triggered by the detecting, a counting of time,
to stop, triggered by the discerning, the counting of time, and
to include in the report an information element indicative of the counted time.

16. An apparatus according to claim 15, wherein
in case the second event relates to a communication link established using the first access technology and
in case the time counted by the timer is smaller than a threshold value, the report is composed to include an information element indicative that the second event occurred with a tolerable delay.

17. An apparatus according to claim 15, wherein
in case the second event relates to a communication link established using the first access technology and
in case the time counted by the timer is greater than or equal than a threshold value,
the report is composed to include an information element indicative that the second event occurred with an intolerable delay.

18. A computer program product comprising a non-transitory computer-readable storage medium bearing computer program code embodied therein for use with a computer, the computer program code comprising code for performing the method of claim 10.
